(19) United States
(12) Patent Application Publication
(10) Pub. No.: US 2016/0026971 A1
(43) Pub. Date: Jan. 28, 2016

(54) MODULE-BASED TRACEABILITY FOR AN AUTOMATED SUPPLY NETWORK

(71) Applicant: GLOBALFOOD NETWORKS INC., Montreal, (CA)

(72) Inventors: Eik KLEIN, Montreal (CA); Hadi NASRALLAH, Montreal (CA)

(21) Appl. No.: 14/776,789

(22) PCT Filed: Mar. 11, 2014
(86) PCT No.: PCT/CA2014/000182

§ 371 Date: Sep. 15, 2015

Related U.S. Application Data
(60) Provisional application No. 61/787,600, filed on Mar. 15, 2013.

(51) Int. Cl. G06Q 10/08; G06Q 40/00

(52) U.S. Cl. CPC G06Q 10/087; G06Q 40/12

(57) ABSTRACT

A system and method is provided that enables traceability within a professional networking system for consumer products, accessible to all members of the supply chain, from source to customer. The system is able to: identify, select and search for a product; create, post and match listing for buyers and sellers; trade, auction and confirm purchases; arrange logistics, such as but not limited to transportation; provide/obtain full traceability; and record and archive transactions.

### TECHNICAL FIELD

The present disclosure relates to a system and method for implementing module-based traceability in an automated a supply network.

### BACKGROUND

Consumer and government demands tend to shift at a rapid pace. Emerging requirements today include document-supported traceability through all levels of the supply chain, transparency of business processes and procurement from sustainable, renewable stocks only.

The rising costs of doing business, global competition and the need for timely planning and quick response times to changing environment and market conditions create additional challenges for buyers and sellers.

### SUMMARY

In an aspect, there is provided a computer-implemented method for document-supported module-based traceability throughout a supply chain of provider, the method comprising: after a transaction is completed, a computer generated seller agent creating a traceability module for a particular load of product to be sent to a buyer; the seller agent asking the seller whether or not a service provided was used to deliver or store the product; the seller agent receiving a response indicating whether or not a service provider was used; if a service provider was used, the seller agent creating one traceability module for each service provider and a traceability engine sending each service provider an invitation to complete the respective traceability module; the seller agent asking the seller if the product was purchased from another buying/selling party; the seller agent receiving a response indicating whether or not the product was purchased from another buying/selling party; and if the product was purchased from another buying/selling party, the selling agent creating one traceability module for each buying/selling party from which the product was purchased and a computer implemented traceability engine sending each buying/selling party an invitation to complete the respective traceability module.

In another aspect, there is provided a network for implementing any of the methods described herein, the network comprising: the seller agent; the traceability engine; and a database for storing the traceability modules.

In another aspect, there is provided one or more computer readable medium having computer readable instructions stored thereon that when implemented cause a processor to implement any of the methods described herein.

### BRIEF DESCRIPTION OF THE DRAWINGS

FIG. 1 is a block diagram of a purchasing network in accordance with an example embodiment of the present disclosure;

FIG. 2 is a block diagram of a system in accordance with an example embodiment of the present disclosure;

FIG. 3 is a flowchart of a method in accordance with an example embodiment of the present disclosure;

FIG. 4 is a block diagram of a negotiation network in accordance with an example embodiment of the present disclosure;

FIG. 5 is a block diagram of a negotiation network in accordance with an example embodiment of the present disclosure;

FIGS. 6A to 6C are a flowchart of a method in accordance with an example embodiment of the present disclosure;

FIG. 7 is a block diagram of a registration network in accordance with an example embodiment of the present disclosure;

FIG. 8 is a flowchart of a method in accordance with an example embodiment of the present disclosure;

FIG. 9 is a flowchart of a method in accordance with an example embodiment of the present disclosure;

FIG. 10 is a block diagram of a traceability network in accordance with an example embodiment of the present disclosure; and

FIG. 11 is a flowchart of a method in accordance with an example embodiment of the present disclosure.

### DETAILED DESCRIPTION

Reference will now be made in detail to implementations of the technology. Each example is provided by way of explanation of the technology only, not as a limitation of the technology. It will be apparent to those skilled in the art that various modifications and variations can be made in the present technology. For instance, features described as part of one implementation of the technology can be used on another implementation to yield a still further implementation. Thus, it is intended that the present technology cover such modifications and variations that come within the scope of the technology.

The system and method described herein enables the creation of a professional networking system for semi-processed food and feed products, accessible to all members of the supply chain, from farm and sea, to distributor and grocer. Although described at times with reference to a food network, the system is adaptable to any supply chain network.

Additionally, the system allows for the provision of efficient trading and auctions platforms where trusted suppliers and buyers meet to trade, conduct forward or reverse bidding events, and create new business opportunities.

The system described allows for transparency, sustainability and traceability.

In use, the system unifies the separate buying and selling steps to create a seamless, linear process. Benefits include a standard format, efficient processes, and lower cost than existing systems.

In summary, the system optimizes businesses processes by—
Reducing planning and response times to market changes
Increasing marketing and sourcing abilities through automation and global matching of product profiles
Enabling uninterrupted supply through technology that automates purchasing and shipping feature
Achieving optimal quality and competitive pricing

The system described herein performs the following steps:
1) Identify, select and search for a product
2) Create, post and match listing for buyers and sellers
3) Trade, auction and confirm purchases
4) Arrange logistics, such as but not limited to transportation
5) Provide/obtain full traceability
6) Record and archive transactions

The formatted approach, automated listings, centralized corporate profiles, feedback and ratings, and interfacing of participants results in lower administrative costs. Sustainable sourcing, full traceability, product profile matching and the lack of middlemen results in lower product costs. The lower costs results in improved profit margins for the buyers and the sellers.

In a first aspect, there is provided a method, system and computer program product for the fully automated initiation and completion of a purchasing process, including product delivery, by means of (1A) a Reverse Auction or (2A) a Request for an Offer (trade) between a purchasing party and a multiple of potential selling parties. In the case of a reverse auction, the method includes the detection of inventory levels at the purchaser's storage or retail facilities, the dispatching of email notifications to potential selling parties, public or private, inviting them to participate in a reverse bidding event and the actual auction, which ultimately determines the winning selling party.

The detection of inventory levels at the purchaser's storage and/or retail outlets is performed using terminals connected via communications network and software-based agents, which are controlled by the purchasing party.

Upon determining the selling party in the reverse auction or the trade (request for offer), the method, system and computer program include the automatic notification of either selling or purchasing party's transport company, subject to the inco-terms agreed upon between the parties, for automatic pick-up and delivery of the product sold and purchased to the purchasing party's designated storage or retail facility.

In a second aspect, there is provided a method, system and computer program product for the selling and purchasing process between the purchasing and selling parties permitting each party to trade and negotiate simultaneously with multiple trading partners until such time a transaction has been successfully concluded with one of the participating parties. The method, system and computer program enables purchasing and/or selling parties to screen, compare and react to multiple offers or requests for offers simultaneously, to respond (trade) by placing counteroffers—subject to final confirmation or firm for reply within a specific time frame—, amend certain criteria of an offer to sell or request for offer, including their terms and conditions, with the goal to obtain and confirm the best terms and conditions for either the purchasing or the selling party, as the case may be.

In a third aspect, there is provided a method, system and computer program product for the fully automated conversion of a member's or market participant's product profile into offers or requests for offers, depending on members' or market participants' status as a purchasing party, a selling party or both.

The method, system and computer program include the retrieval of a member's or non-registered market participant's status as a purchasing party, a selling party or both and their respective product profiles.

The status of the member or non-registered market participant as a purchasing party, a selling party or both determines how their respective product profile(s) will be listed and displayed on a website. If the member or market participant is a selling party, the listing displays as an offer to sell; if the member or market participant is a purchasing party, the listing displays as a request for an offer; if the member or market participant is a purchasing and a selling party, the listing displays as an offer to sell and as a request for an offer.

In a fourth aspect, there is provided a method, system and computer program product for document-supported module-based traceability throughout the entire supply chain of providers of food- and feed products that do not cross the point of sale, and their respective service providers.

In some embodiments, the method, system and computer program include pre-formatted modules, which meet the requirements of any participant within the supply chain. Non-limiting examples of the modules include (A) buying and selling parties, such as seed-, feed ingredient and food contact packaging suppliers, fishermen, farmers or growers, processors, distributors and retailers; (B) service providers, such as transport air, road, rail, water and/or storage providers. In an embodiment, modules are auto-loaded or pre-filled by participant to the extent information is available, or are emailed from a purchasing party to a preceding selling party in the chain, or a service provider to the chain, once a transaction record has been issued. Invitations that link and provide access to the invitee's traceability module are to be completed by the invitee for re-submission to the inviting party.

In an embodiment, modules are displayed graphically and in chronological order under their respective transaction number and marked as “completed” or “action required” depending on their status. In an embodiment, completed modules cannot be edited. In an embodiment, transaction-relevant documents are attached to each module. All modules of the supply chain are automatically archived by the purchasing party and instantly available upon request.

Embodiments of each of the four aspects will now be described in detail. Although, each aspect is described referring to a specific network, it is to be understood that the components of the networks for the various aspects can be combined into one network. Additionally, components of the network for one aspect may perform the functions of more than one aspect.

### Aspect 1—Reverse Auction/Request for Offer

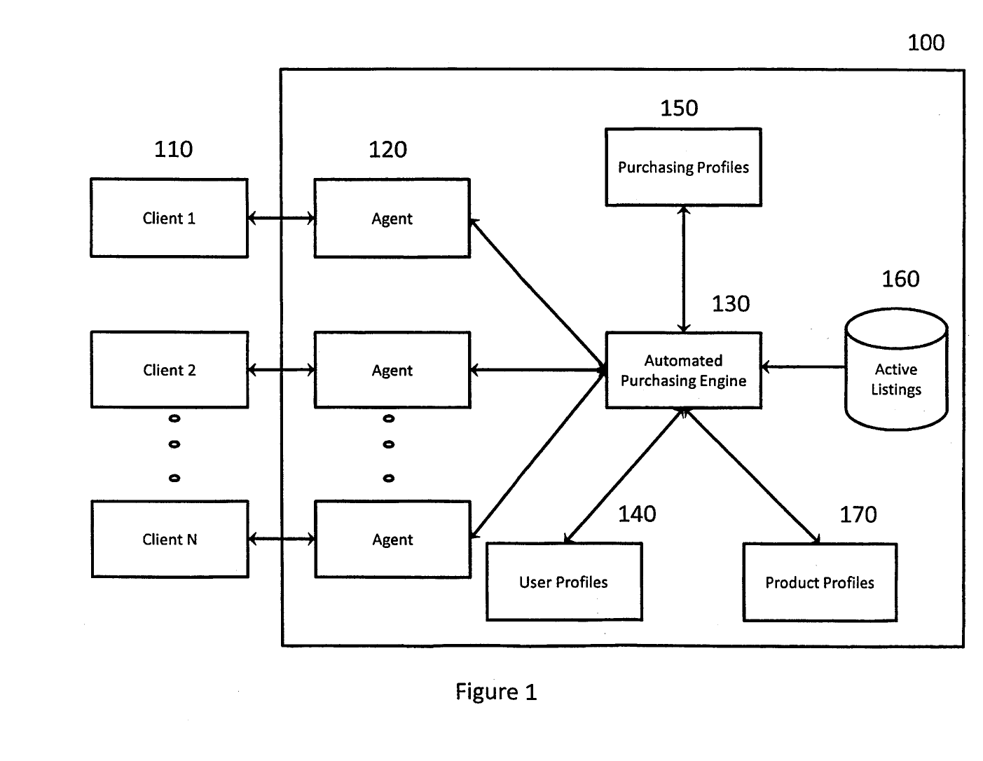

Referring to FIGS. 1 to 3, automated purchasing according to an embodiment of the first aspect will now be described. Referring to FIG. 1, an embodiment of the automated purchasing is implemented in a purchasing network 100. Any number (N) of clients 110 (shown as Client 1, Client 2, . . . Client N) can access the network through a communication system such as but not limited to the internet, an intranet, a WAN, or a LAN. The clients access the network using a client device. The network itself comprises an agent 120 representing each client. The agent is a module for each client that can act on behalf of the client. Each agent 120 is in communication with an automated purchasing engine 130. The agent modules and the automated purchasing engine 130 can be implemented as software, hardware, firmware, or combinations thereof. The automated purchasing engine 130 has access to user profiles 140, purchasing profiles 150, active listings 160, and product profiles 170, each of which is a stored in a database. User Profiles 140 includes a database containing the profile of each registered user. For each register user, the profile contains general information about the user (name, location, company, company characteristics, etc.) as well as specification information required to verify the authenticity of the user (Credit reference, associations, etc. . . . ). Product Profiles 170 includes a database containing a description of each product a user buys or sells. Active Listings 160 includes a database of listings to either buy or a sell a product. A listing can be one of the following types: forward auction, reverse auction, request for offer, and offer to sell. Purchasing profiles 150 includes a database per user/product that contains the rules of what occurs in the event the inventory level for that user/product is detected to be low. In some embodiments, there is a separate database for each of the user profiles 140, purchasing profiles 150, active listings 160, and product profiles 170. In other embodiments, some or all of the profiles or listings are combined in a single database. In some embodiments, all of the components of the network 100 operate on one or more server. In some embodiments, the components operate on one or more computer.

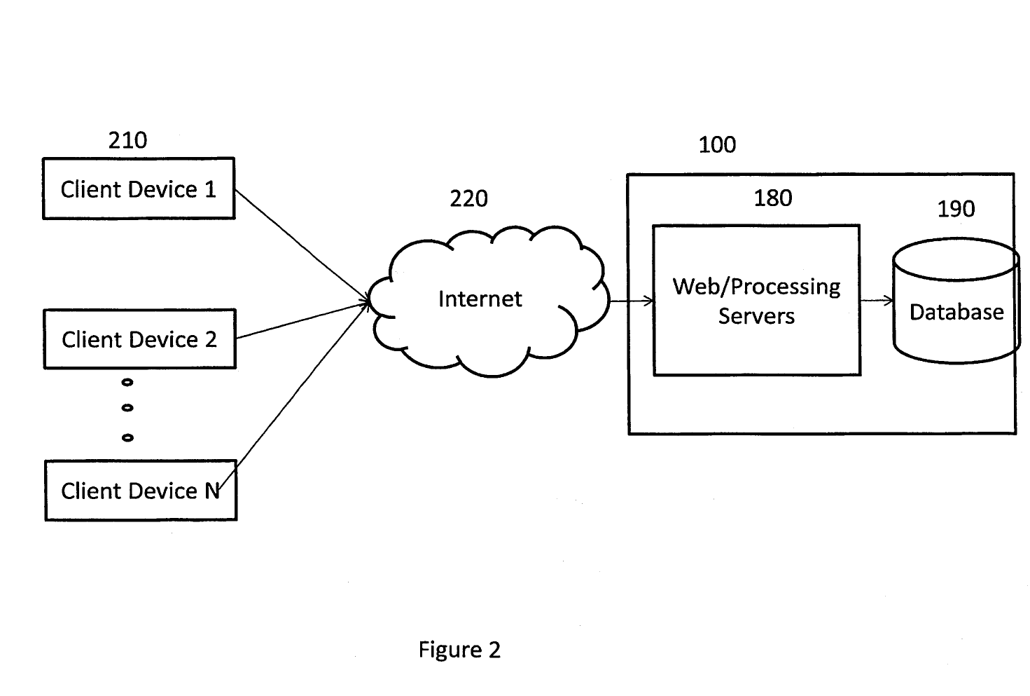

The system for implementing the network of FIG. 1 will be described with reference to FIG. 2. Each client 110 can access the purchasing network 100 though the internet 220 using a client device 210. Non-limiting examples of client devices are computers, tablets, and smart phones. The network 100 is comprised of one or more servers 180, such as web servers and processing servers) and one or more databases 190. The user profiles 140, purchasing profiles 150, active listings 160, and product profiles 170 are stored on the database 190. The automated processing engine 130 and the agents run on the server(s) 180. Although the database 190 is shown separately from the server 180, in some embodiments the database is located on one of the servers 180.

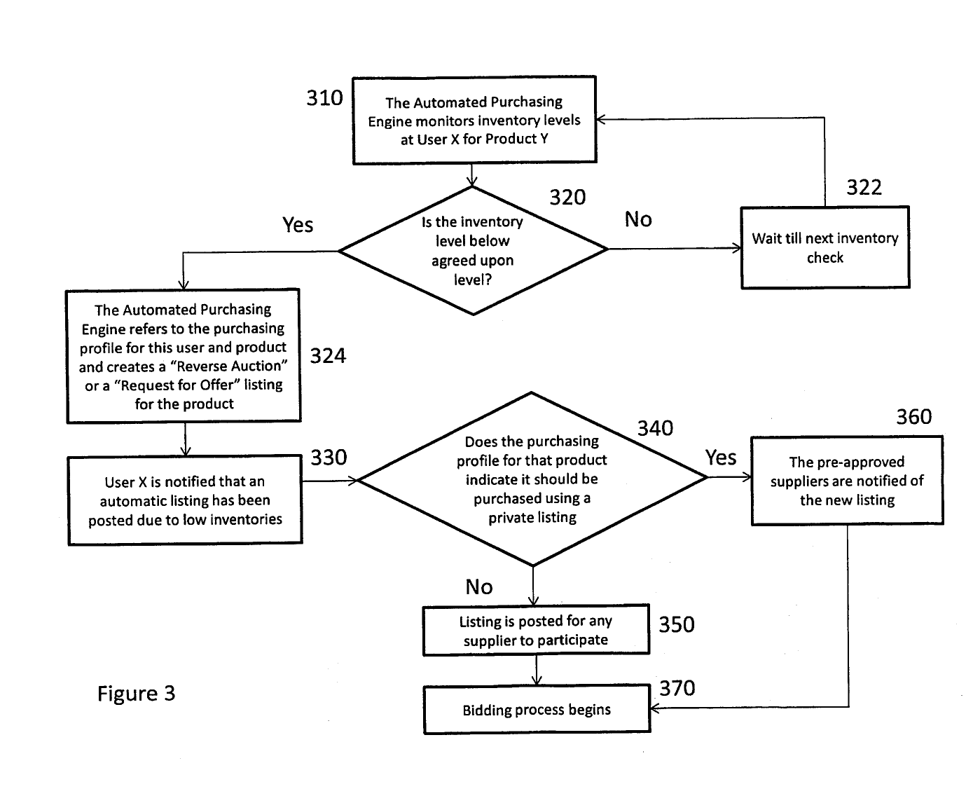

Referring to FIG. 3 a method implemented by the network and system of FIGS. 1 and 2 will now be described. At action 310 the automated purchasing engine 130 monitors an inventory level for a User X for a product Y. The monitoring, in some embodiments, comprises periodic checks. At decision block 320, a determination is made of whether the inventory level is below an agreed upon level. If the answer is NO, the method proceeds to action 322, which is to wait until the next inventory check at which point the method starts over at action 310. If the inventory level is below the agreed upon level, the method proceeds to action 324, where the automated purchasing engine 130 refers to the purchasing profile 150 or User X and product Y and creates—
(1A) A “Reverse Auction” listing for the product Y. A “Reverse Auction” is a listing in which a poster (the buyer) commits to purchase a certain product type with specific product specifications. Then at action 330, User X is notified that an automatic listing has been posted due to low inventories. Then a determination 340 is made of whether the purchasing profile for product Y indicates that it should be purchased using a private listing. If the answer is yes, pre-approved suppliers are notified of the new listing at action 360. If there is no indication to use a private listing, the listing is public and posted for any supplier to participate at action 350. The method continues with the suppliers bidding on providing the product Y.
(1B) A “Request for Offer” listing for the product Y. “Request for Offer” is a listing in which a poster is offering to buy a certain product type with a specific product specification. Then at action 330, User X is notified that an automatic listing has been posted due to low inventories. Then a determination 340 is made of whether the purchasing profile for product Y indicates that it should be purchased using a private listing. If the answer is yes, pre-approved suppliers are notified of the new listing at action 360. If there is no indication to use a private listing, the listing is posted for any supplier to participate at action 350. The method continues with the suppliers starting to provide offers pertaining to the product Y.

In some embodiments, for each user a mechanism for monitoring inventory levels is established over the internet. Non-limiting examples of mechanisms for monitoring inventory include:
An email sent from the user to the automated purchasing engine on a regular basis containing inventory level of the desired products. Upon the period receipt of the email, the automatic purchasing engine kicks into action if the inventory levels are below threshold (Push method)
A web service sitting at the user site that can be accessed over the public internet or secure connection that returns the inventory level of the desired products. On a period basis, the automatic purchasing engine will poll the web service to determine the inventory levels. (Pull method)
A website that can be accessed over the public internet or secure connection that display the inventory level of the desired products. On a period basis, the automatic purchasing engine will poll the website to determine the inventory levels. (Pull method)
   Aspect 2—Simultaneous Negotiating with Multiple Partners

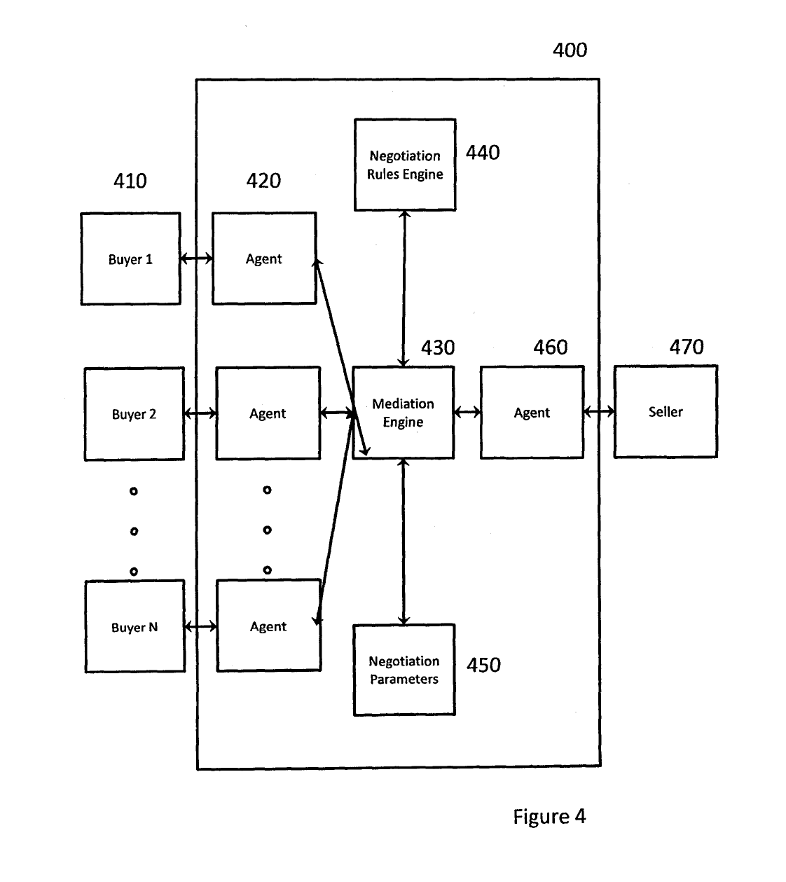

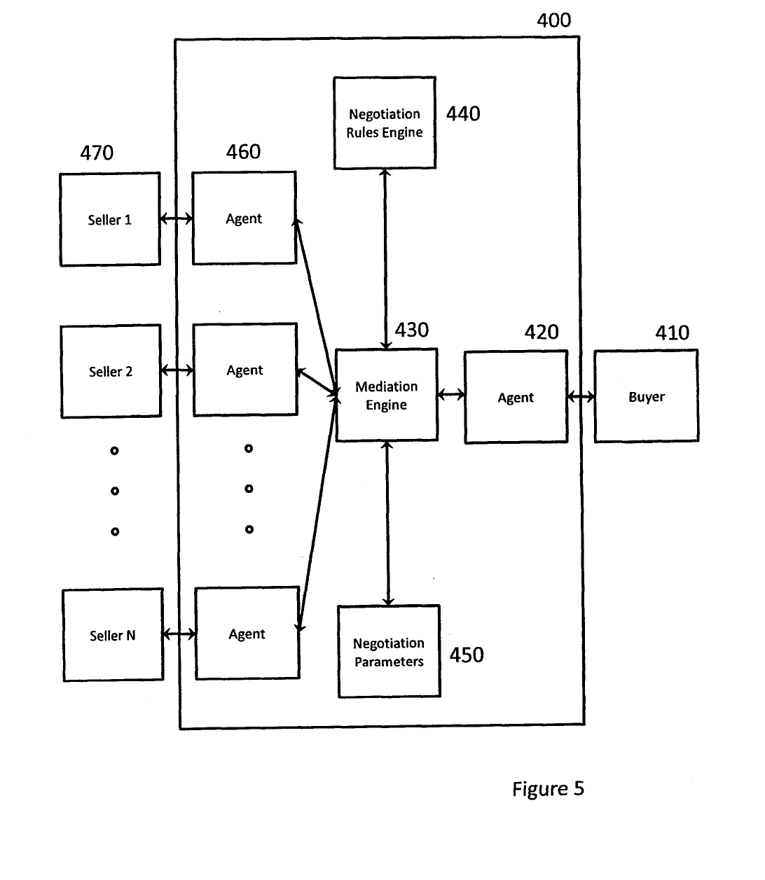

An “Offer to Sell” is a listing in which the poster (seller) is offering to sell a certain product type with a specific product specification. A “Request for Offer” is a listing in which the poster is looking to buy a certain product type with a specific product specification. Systems for automated handling of offers to sell and requests for offer will now be described with reference to FIGS. 4 and 5.

Referring to FIG. 4, an “Offer to Sell” is implemented in a negotiation network 400. Any number (N) of buyers 110 (shown as Buyer 1, Buyer 2, . . . Buyer N) can access the negotiation network through a communication system such as but not limited to the internet, an intranet, a WAN, or a LAN. The buyers access the network using a client device. The network itself comprises a buyer agent 420 representing each buyer. A buyer agent is a module for each buyer that can act on behalf of the buyer. Each agent 420 is in communication with mediation engine 430. The agent modules and the mediation engine 430 can be implemented as software, hardware, firmware, or combinations thereof. The mediation engine 430 has access to a negotiation rules engine 440 and negotiation parameters 450. Negotiation Parameters is a database that contains the listing's parameters that can be negotiated (e.g. price, quantity, delivery location, payment terms, etc.). Negotiation Rules Engine is a database that contains the rules to be used during the negotiation. The mediation engine is the agent that uses the negotiation rules engine and the negotiation parameter to facility the negotiation process between the buyers and sellers. The mediation engine is also in communication with a seller agent 460, which is a module that can act on behalf of a seller 470. In some embodiments, all of the components of the network 400 operate on one or more servers. In some embodiments, the components operate on one or more computers.

Referring to FIG. 5, the negotiation network 400 can also be used for negotiating “Requests for Offers”. The negotiation network 400 of FIG. 5 is the same as in FIG. 4 with the exception that there are N sellers 470 (shown as Seller 1 . . . Seller N) with a seller agent 460 for each seller and there is only one buyer 410 and one buyer agent 420.

It is to be understood that FIGS. 4 and 5 are representative examples only and the negotiation network 400 can handle multiple negotiations for any number of buyers or sellers.

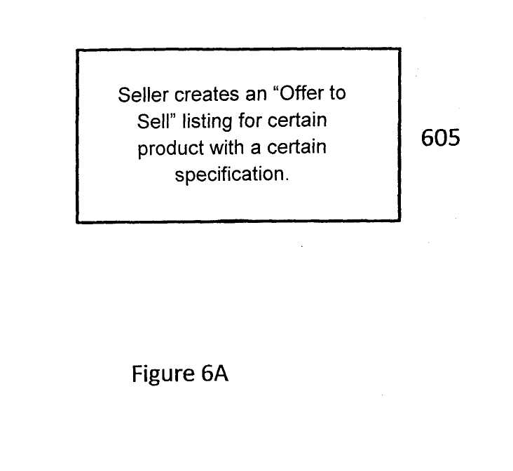

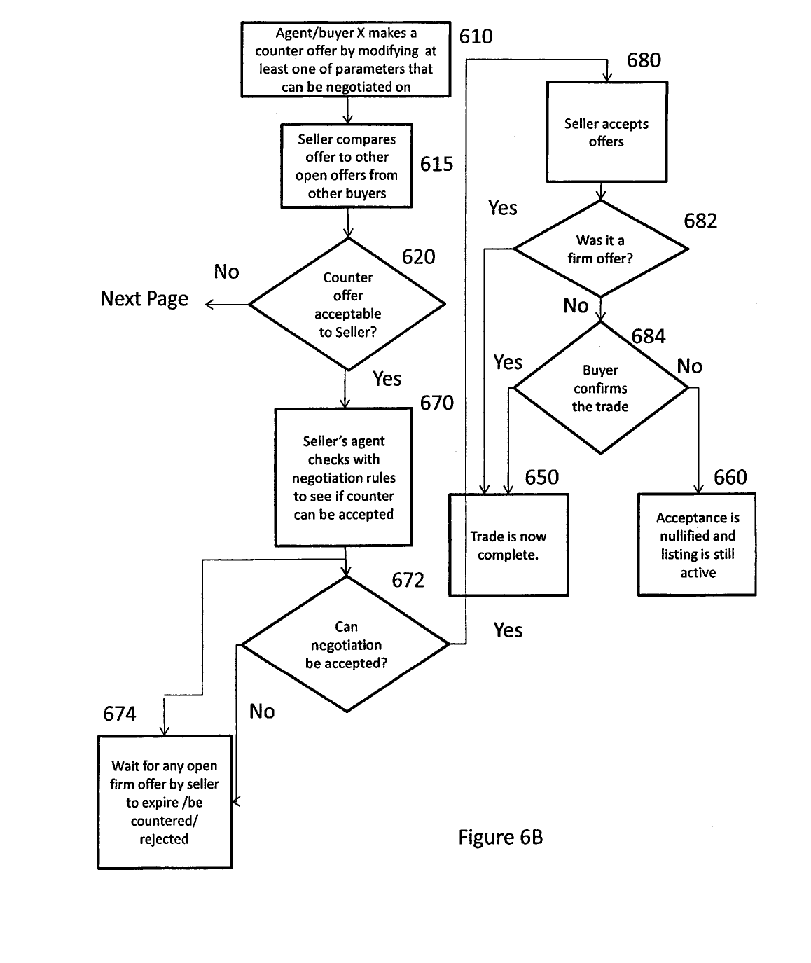

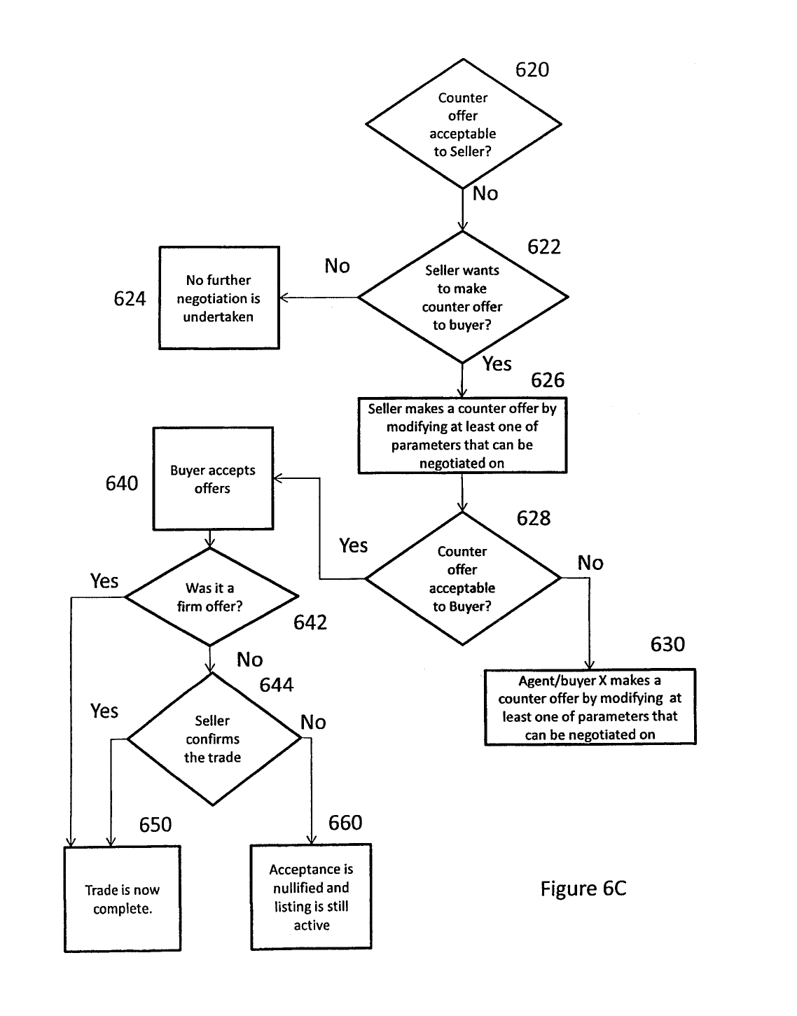

Referring to FIGS. 6A to 6C an example embodiment of a method using a set of negotiation rules to be followed by multiple buyers and sellers will now be described. The following method applies for “Offer to Sell” listings where the negotiations take place between one seller and multiple buyers, as well as for “Requests for Offers” listings where the negotiations take place between one buyer and multiple sellers.

In an “Offer to Sell” listing, at action 605 a seller 470 creates a listing to sell a certain quantity of product which is then posted on the GFN website by the seller's agent 460. In creating a listing, there are a number of parameters/terms 450 that the seller specifies but will be up for negotiation with the buyers. Non-limiting examples include price, quantity, currency, terms of payment, and delivery date.

At action 610, an agent for Buyer X makes a Counter Offer by modifying at least one of parameters that can be negotiated on. At action 615, seller compares the offer to other open offers from other buyers. At decision 620 a determination is made of whether or not the counter offer is acceptable to the seller. If the counter offer is not acceptable, the method continues to decision 622 where the seller decides whether to make a counter offer to the buyer (FIG. 6C). If the seller decides not to make a counter offer, no further action is taken (action 624). If the seller decides to make a counter offer, the method proceeds to action 626 with the seller, through his agent, making the counter offer by modifying at least one of the parameters that can be negotiated on and submitting it to the mediation engine for validation. Then at decision 628 the buyer decides if the counter offer from the seller is acceptable. If the counter offer is not acceptable to the buyer, the buyer, through his agent, can make a further counter offer by modifying at least one of the parameters that can be negotiated on (action 630). If the seller's counter offer is acceptable to the buyer, the method continues with action 640 where the buyer accepts the offer. The acceptable can be a firm offer or not (in other words, a time limited “valid until” offer or “subject to final confirmation” offer) (decision 642). If it is a firm offer, the trade is complete (action 650). If the offer is not a firm offer, the seller is asked to confirm the trade (decision 644). If the seller confirms the trade, the trade is complete (action 650). If the seller does not confirm the trade, the acceptable is nullified and the listing is still active (action 660).

If at decision 620, the initial counter offer from the buyer is acceptable to the seller, the seller's agent checks with the mediation engine and negotiation rules 440 to see if the counter offer can be accepted (action 670). At decision 672 a determination is made by the mediation engine using the negotiation rules engine of whether or not the negotiation can be accepted. If the negotiation cannot be accepted, the method proceeds with waiting for any open offers by the seller to expire or be countered or rejected (action 674) at which point decision 672 is repeated.

If the negotiation can be accepted, the seller accepts the offer at action 680. A determination is made by the mediation engine as to whether the seller's acceptance is a firm offer (decision 682). If the seller's acceptance is a firm offer, the trade is complete (action 650). If the seller's acceptance is not a firm offer, the buyer is asked to confirm the trade (decision 684). If the buyer confirms the trade, the trade is complete (action 650). If the buyer does not confirm the trade, the acceptance is nullified by the mediation engine and the listing is still active (action 660).

Thus, after the listing is posted, a buyer who is interested in the product but does not agree with all the terms can make a counter offer to the seller. Through the buyer's agent, a counter offer is created (action 610) by modifying one or more of the terms specified by the seller. The buyer specifies whether the counter offer is “subject to final confirmation” or is a “firm offer valid until a specific time and date”. If the counter offer is a “firm offer”, and the seller accepts the counter offer, the transaction is then marked as completed. If the buyer's counter offer is “subject to final confirmation” and the seller accepts the offer, the buyer needs to confirm the acceptance to complete the transaction.

Once the buyer creates a counter offer, the buyer's agent sends the counter offer to the mediation agent who informs the seller of the new counter offer. At this point, the seller may have multiple counter offers from multiple buyers. The seller's agent then allows the seller to compare the different counter offers based on their terms and conditions (action 615).

The seller can then accept any of the counter offers or counter one or more of the counter offers (decision 620). Through the seller's agent, the seller can create the counter offers by modifying the terms specified by the buyer's counter offers (e.g. price, quantity, currency, terms of payment, etc. . . . ) (Action 626). The seller's counter offers can be “subject to final confirmation” or “a firm offer valid until a specific time and date set by the seller”. When the seller's agent accepts a counter offer or counters a buyer's counter offer, the mediation engine needs to check a rules engine to see if such an action is allowed.

A non-limiting set of negotiation rules that need to be followed in one embodiment includes:
A seller cannot create more than one “firm offer valid until a specific time and date” to more than one buyer
A seller cannot accept a counter offer from a buyer if the seller still has an outstanding “firm offer valid until a specific time and date” to another buyer
A buyer can only have one active counter offer and must wait for the seller to respond before submitting another counter offer.

In some embodiments, if a buyer or seller does not respond to a firm offer or counter offer within the time and date limit set by the seller or buyer, the firm offer or counter offer reverts to an offer or counter offer subject to final confirmation.

### Aspect 3—Automatic Conversion of Product Profiles to Offers to Sell or Requests for Offers During Registration

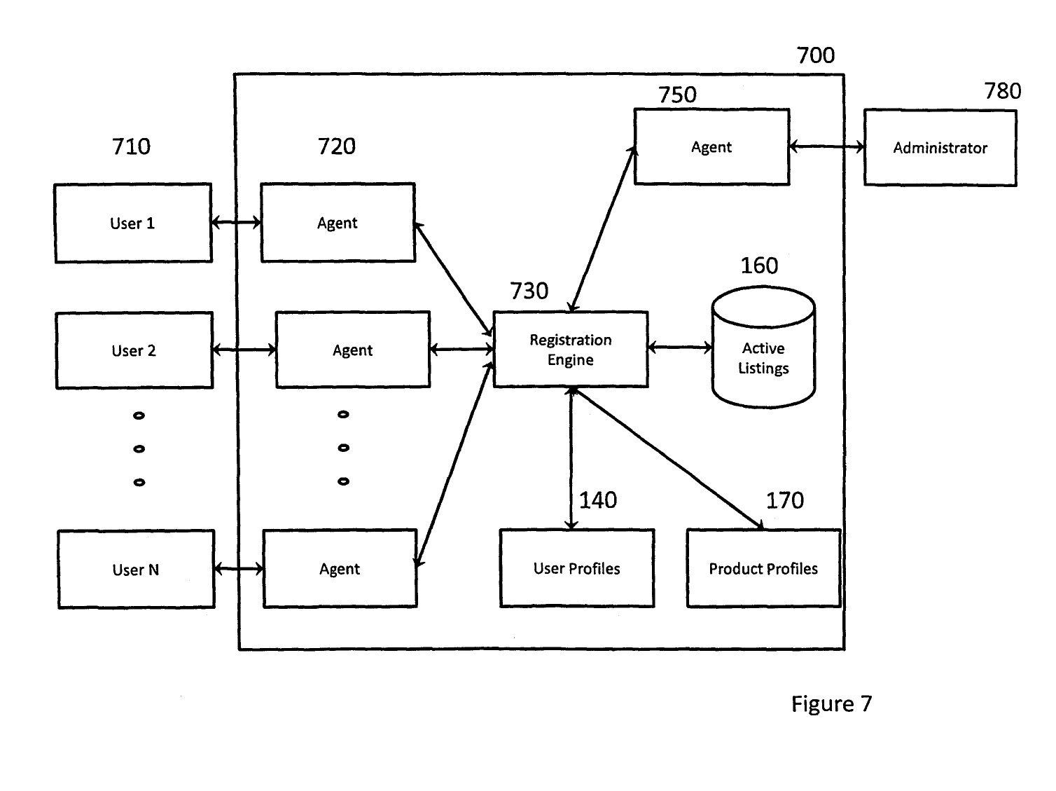

Referring now to FIGS. 7 to 10 a registration process according to the third aspect will now be described in detail.

Starting with FIG. 7, a registration network 700 for implementing the registration process will now be described. Any number (N) of users 710 (shown as User 1, User 2, . . . User N) can access the registration network through a communication system such as but not limited to the internet, an intranet, a WAN, or a LAN. The users access the network using a client device. The network itself comprises a user agent 720 representing each user. The user agent is a module for each user that can act on behalf of the user. Each user agent 720 is in communication with an registration engine 730. The agent modules 720 and the registration engine 730 can implemented as software, hardware, firmware, or combinations thereof. The registration engine 730 has access to user profiles 140, active listings 160, and product profiles 170, each of which is a stored in a database. In some embodiments, there is a separate database for each of the user profiles 140, active listings 160, and product profiles 170. In other embodiments, some or all of the profiles or listings are combined in a single database. An administrator 780 can access the registration engine 730 through an administrator agent 750. The administrator 780 creates the profiles on behalf of the market participants. In some embodiments, all of the components of the registration network 700 operate on one or more server. In some embodiments, the components operate on one or more computer.

In an embodiment, through a web enabled device (PC, Laptop, Tablet, Smartphone, etc.), a user 710 completes a registration application. Non-limiting examples fields on the registration application include:
User Profile (Name, Company, Address, whether the user is a buyer or seller, etc.)
Product profiles: A list of all products and their specifications that the user buys or sells

Once the registration is complete, the registration engine 730 converts the user profile and product profiles to active listings on the GFN web site. If the user is a seller of product X, the product profile for product X is converted to an active “Offer to Sell” listing. If the user is a buyer of product X, the product profile for product X is converted to an active “Request for Offer”. The information contained in the user and product profiles is used by the registration engine 730 to create the active listing.

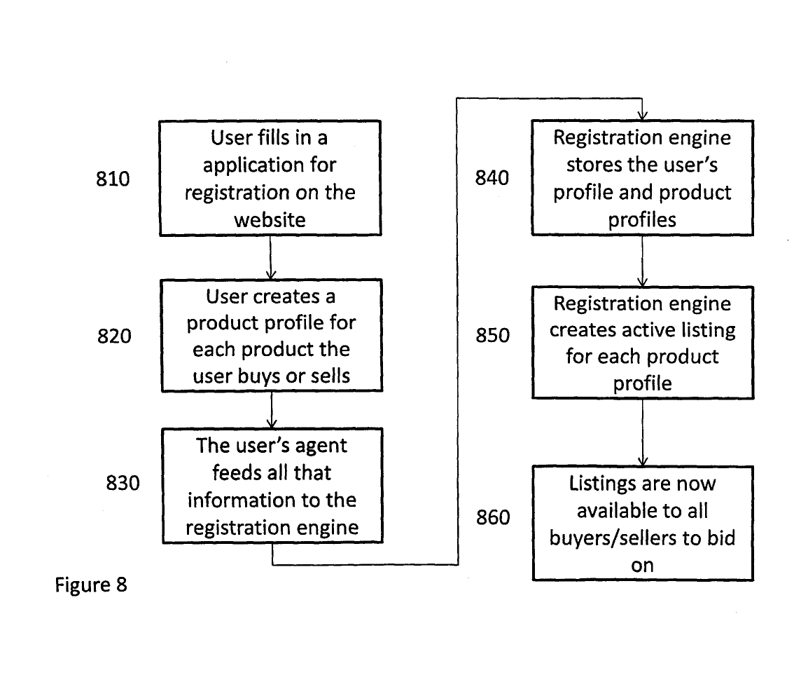

An example embodiment of user registration will now be described with reference to FIG. 8. At action 810, a user 710 fills in an application for registration on a website. At action 820, the user 710 creates a product profile for each product that the user wishes to buy and sell using the supply network. At action 830, the user's agent 720 feeds the registration information and product profiles to the registration engine 730. At action 840, the registration engine stores the user's profile and product profiles in the user profile database 140 and the product profile database 170, respectively. At action 850, the registration engine 730 creates an active listing in the active listings database 160 for each product profile. The listing then becomes available to all buyers/sellers to bid on (action 860).

A market participant (buyer or seller) can also be registered by the administrator 780. Through a web enabled device (PC, Laptop, Tablet, Smartphone, etc.), the administrator 780 completes a market participant's registration application on behalf of a buyer or seller. The registration application includes:
User Profile (Name, Company, Address, whether the user is a buyer or seller, etc.)
Product profiles: A list of all products and their specifications that the user buys or sells

Once the registration is complete, the registration engine 730 converts the user profile and product profiles to active listings. If the user is a seller of product X, the product profile for product X is converted to an active “Offer to Sell” listing. If the user is a buyer of product X, the product profile for product X is converted to an active “Request for Offer”. The information contained in the user and product profiles is used by the registration engine 730 to create the active listing.

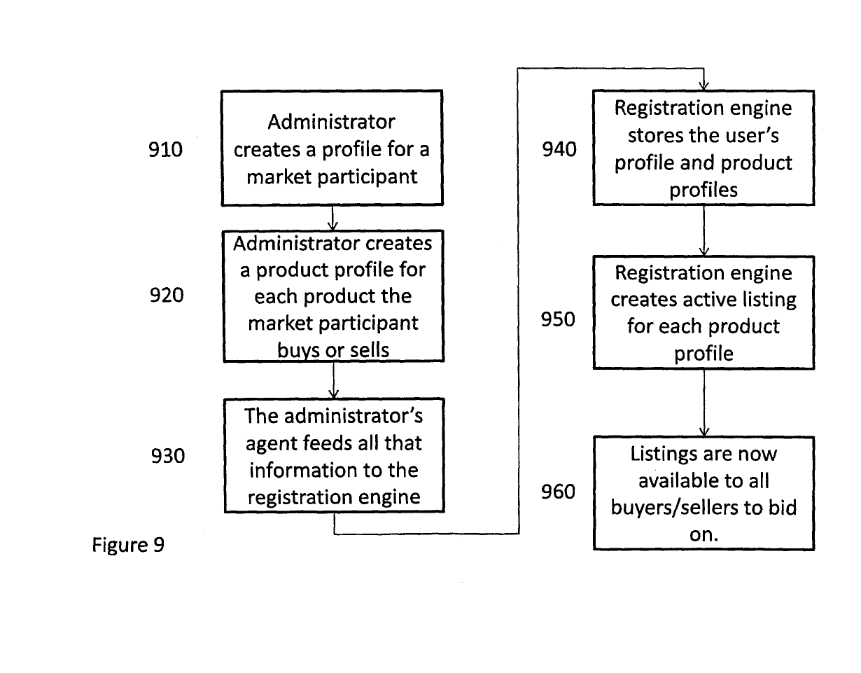

FIG. 9 is a flowchart of an embodiment a method whereby the administrator 780 registers the market participant. All of the actions are the same as in the method described with reference to FIG. 8 except that the administrator/administrator's agent performs the tasks rather than the user/user's agent. Thus, at action 910, an administrator 780 fills in an application for registration on a website. At action 920, the administrator 780 creates a product profile for each product that the market participant wishes to buy and sell using the supply network. At action 930, the administrator's agent 750 feeds the registration information and product profiles to the registration engine 730. At action 940, the registration engine stores the administrator's profile and product profiles in the user profile database 140 and the product profile database 170, respectively. At action 950, the registration engine 730 creates an active listing in the active listings database 160 for each product profile. The listing then becomes available to all buyers/sellers to bid on (action 960).

### Aspect 4—Module-Based Traceability

In some embodiments, after a trade or auction is successfully completed, traceability information is entered into specific modules pertaining to the product through all levels of the supply chain, from its source of origin to destination.

A traceability module represents a party/company handled the product at some point in the supply chain, from the source to its destination. There are two non-limiting types of parties/companies:

### 1. Providers of Products:

Feed/seed suppliers
Food contact material suppliers (packaging materials)
Hatcheries/nurseries
Fishermen, farmers and growers
Processors
Distributors, Traders and Re-packers
Retailers

In some embodiments, when a trade or auction is completed, the seller is responsible for selecting and completing his respective Provider of Product module for each shipment (load) to be sent to the buyer. For example, if the seller is a processor, he needs to select and complete the required information for the processor module; if the seller is a farmer or fisherman, he needs to select and complete the required information in the farmer or fisherman module, etc.

The seller is also responsible to select a module for each of his previous suppliers of product from whom he has purchased raw materials to create the product he sold to the buyer. For example, the seller, who is a processor and has purchased the product from a farmer or fisherman, needs to select the appropriate farmer or fisherman module. When selecting the respective module, an invitation with a link to the module is sent to the farmer/fisherman to complete all the required information contained in the module(s).

Each previous supplier who receives an invitation to complete a module must complete all the necessary information for that module. This repetitive module compilation process continues all the way to the origin of the product.

Once any of the modules have been completed, the buyer is responsible for approving the module. “Approving the module” means that all necessary information has been provided by the user (any previous supplier) completing the module to the satisfaction of the buyer.

### 2. Providers of Services:

Transport companies (air, rail, road and/or water)
Storage companies
Quality, inspection, verification and certification companies.

Depending on the inco-terms agreed upon between a buyer and a seller or any previous suppliers, the inco-terms are reflected in the GFN transaction record and stipulate who is responsible for shipping the product. Either the seller or buyer must select a module for each Service Provider used.

For example, if the seller needs to ship the product to the buyer by truck, the seller selects the road module for the trucking company. If shipment is required by air, the seller selects the air module for the airline. Conversely, if the buyer is responsible for the shipment of the product, it is the buyer who selects the appropriate transport module(s).

When the respective transport module (air, rail, road or water) is selected, an invitation is sent to the transport company with a link to the module requesting that the transport company complete all the required information contained in the module.

Each service provider that receives an invitation to complete a module must complete all the necessary information for that module.

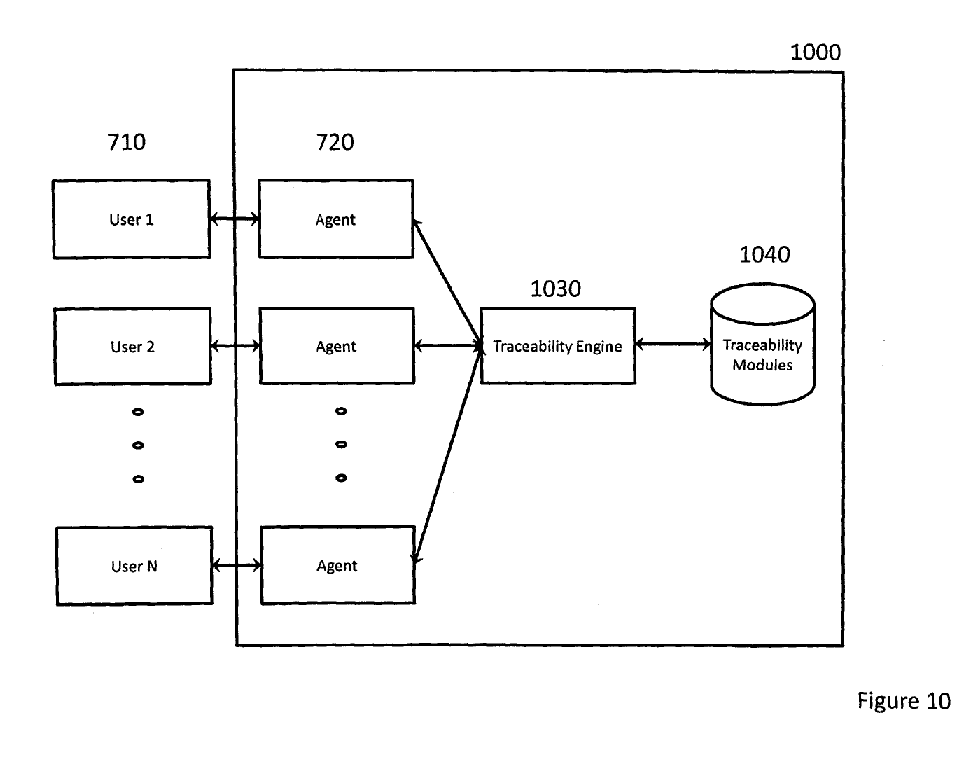

An example network for implementing traceability will now be described with reference to FIG. 10. Any number (N) of users 710 (shown as User 1, User 2, . . . User N) can access a traceability network 1000 through a communication system such as but not limited to the internet, an intranet, a WAN, or a LAN. The users access the network using a client device. The network itself comprises a user agent 720 representing each user. The user agent is a module for each user that can act on behalf of the user. Each user agent 720 is in communication with a traceability engine 1030. The agent modules 720 and the traceability engine 1030 can be implemented as software, hardware, firmware, or combinations thereof. The traceability engine 1030 has access to traceability modules 1040, which are stored in a database. In some embodiments, there is a separate database for each of the user profiles 140, active listings 160, and product profiles 170 described with reference to the other aspects. In other embodiments, some or all of the profiles or listings are combined in a single database. In some embodiments, all of the components of the registration network 1000 operate on one or more server. In some embodiments, the components operate on one or more computer.

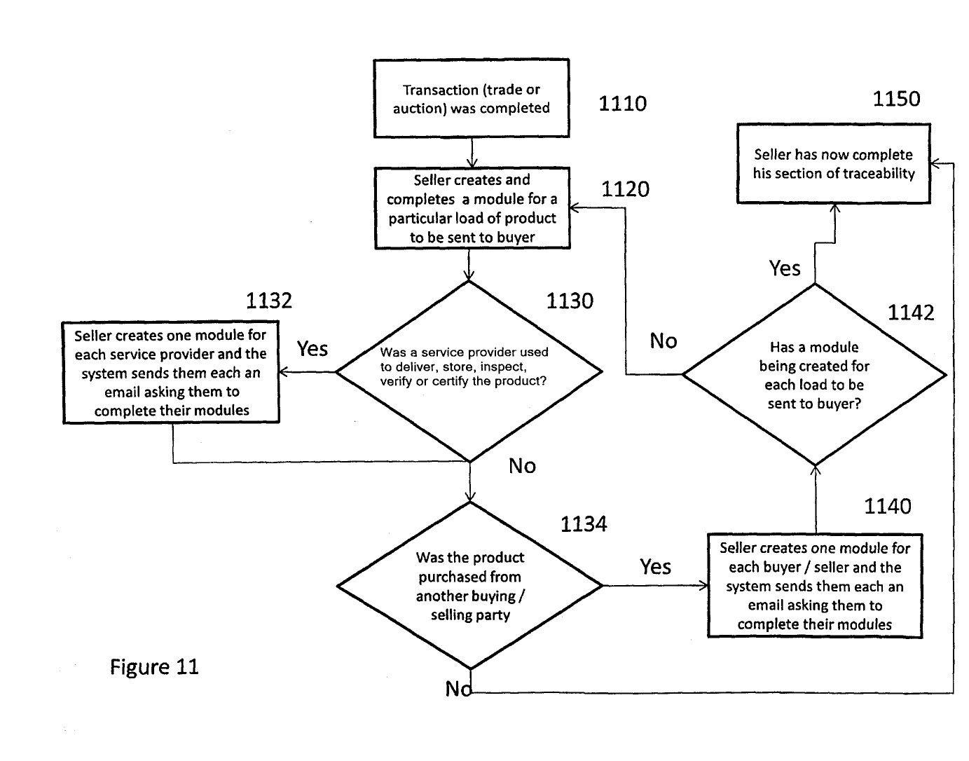

An example method of creating traceability modules will now be described with reference to FIG. 11. This method is from the perspective of the seller. After a transaction is completed (action 1110) the seller selects and completes a module for a particular load of product to be sent to a buyer. At action 1130 the seller is asked whether or not a service provider was used to deliver or store the product (decision 1130). If a service provider was used, the seller is prompted to create one module for each service provider and the system sends each service provider an invitation by email, text message, sms, or any suitable form of communication, asking them to complete their modules (action 1132). The method then proceeds to decision 1134 where the seller is asked if the product was purchased from another buying/selling party. If no service provider was used the method proceeds direction to decision 1134. If the answer is no, the seller section of traceability is complete (action 1150). If the product was purchased from another buyer/selling party, the seller is prompted to create one module for each buyer/seller and the system sends them each a message asking them to complete their modules (action 1140). Then the seller is asked at decision 1142 if a module has been created for each load to be sent to the buyer. If the answer is yes, the seller's section is complete (action 1150). If the answer is no, the method repeats from action 1120 until a module is created for each load.

Although certain methods, apparatus, and articles of manufacture have been described herein, the scope of coverage of this disclosure is not limited thereto. To the contrary, this disclosure covers all methods, apparatus, and articles of manufacture fairly falling within the scope of the claims either literally or under the doctrine of equivalents. For the various methods disclosed, it is to be understood that actions described can be modified and added or removed from the methods. Actions from one example method are not limited to the particular method of the example and can be added to any other method.

Although the present application discloses example methods and apparatus including, among other components, software executed on hardware, it should be noted that such methods and apparatus are merely illustrative and should not be considered as limiting. For example, any or all of these hardware and software components could be embodied exclusively in hardware, exclusively in software, exclusively in firmware, or in any combination of hardware, software, and/or firmware. Accordingly, while example methods and apparatus are described herein, persons having ordinary skill in the art will readily appreciate that the examples provided are not the only ways to implement such methods and apparatus.

Furthermore, the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, removable memory connected via USB, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD, and Blu Ray™. Both processors and program code for implementing each aspect of the technology can be centralized or distributed (or a combination thereof) as known to those skilled in the art.

1. A computer-implemented method for document-supported module-based traceability throughout a supply chain of provider, the method comprising:
after a transaction is completed, a computer generated seller agent creating a traceability module for a particular load of product to be sent to a buyer;
the seller agent asking the seller whether or not a service provided was used to deliver or store the product;
the seller agent receiving a response indicating whether or not a service provider was used;
if a service provider was used, the seller agent creating one traceability module for each service provider and a traceability engine sending each service provider an invitation to complete the respective traceability module;
the seller agent asking the seller if the product was purchased from another buying/selling party;
the seller agent receiving a response indicating whether or not the product was purchased from another buying/selling party; and
if the product was purchased from another buying/selling party, the selling agent creating one traceability module for each buying/selling party from which the product was purchased and a computer implemented traceability engine sending each buying/selling party an invitation to complete the respective traceability module.

2. The method according to claim 1, further comprising the traceability engine creating a pre-formatted traceability module for at least one participant.

3. The method according to claim 1, wherein the seller agent auto-fills at least one field of the modules.

4. The method of claim 1, further comprising the seller agent graphically displaying the modules on a seller device.

5. The method of claim 1, further comprising the seller agent attaching at least one document to one of the modules.

6. The method of claim 1, further comprising the traceability engine archiving at least one module.

7. The method of claim 1, wherein the invitation contains a hyperlink to the traceability module.

8. The method of claim 1, wherein the invitation is sent by any one of email, text message, and sms.

9. A network for implementing a computer-implemented method for document-supported module-based traceability throughout a supply chain of provider, the method comprising:
after a transaction is completed, a computer generated seller agent creating a traceability module for a particular load of product to be sent to a buyer;
the seller agent asking the seller whether or not a service provided was used to deliver or store the product;
the seller agent receiving a response indicating whether or not a service provider was used;
if a service provider was used, the seller agent creating one traceability module for each service provider and a traceability engine sending each service provider an invitation to complete the respective traceability module;
the seller agent asking the seller if the product was purchased from another buying/selling party;
the seller agent receiving a response indicating whether or not the product was purchased from another buying/selling party; and
if the product was purchased from another buying/selling party, the selling agent creating one traceability module for each buying/selling party from which the product was purchased and a computer implemented traceability engine sending each buying/selling party an invitation to complete the respective traceability module, the network comprising:
the seller agent;
the traceability engine; and
a database for storing the traceability modules.

10. The network of claim 9, wherein the seller agent communicates with the traceability engine and acts on behalf of the seller.

11. The network of claim 9, wherein the traceability engine operates on a server.

12. The network of claim 9, wherein the seller agent communicates with a seller device over the internet.

13. The network of claim 9, wherein the seller agent, the traceability engine and the database communicate with each other over the internet.

14. One or more computer readable medium having computer readable instructions stored thereon that when implemented cause a processor to implement a computer-implemented method for document-supported module-based traceability throughout a supply chain of provider, the method comprising:
after a transaction is completed, a computer generated seller agent creating a traceability module for a particular load of product to be sent to a buyer;
the seller agent asking the seller whether or not a service provided was used to deliver or store the product;
the seller agent receiving a response indicating whether or not a service provider was used;
if a service provider was used, the seller agent creating one traceability module for each service provider and a traceability engine sending each service provider an invitation to complete the respective traceability module;
the seller agent asking the seller if the product was purchased from another buying/selling party;
the seller agent receiving a response indicating whether or not the product was purchased from another buying/selling party; and
if the product was purchased from another buying/selling party, the selling agent creating one traceability module for each buying/selling party from which the product was purchased and a computer implemented traceability engine sending each buying/selling party an invitation to complete the respective traceability module.
